(19) United States
(12) Patent Application Publication
(10) Pub. No.: US 2013/0187377 A1
(43) Pub. Date: Jul. 25, 2013

(54) FEMALE CONNECTOR AND METHOD FOR MAKING THE SAME

(71) Applicant: WAN PAO CHEN, Changhwa Hsien (TW)

(72) Inventor: WAN PAO CHEN, Changhwa Hsien (TW)

(21) Appl. No.: 13/355,318

(22) Filed: Jan. 20, 2012

(51) Int. Cl. F16L 27/08; B23P 17/00

(52) U.S. Cl. 285/272; 29/890.144

(57) ABSTRACT

A female connector includes a body, a mediate member and a rotary member. The rotary member has a stepped cylindrical portion which is rotatably inserted in the inner hole of the mediate member. The other end of the mediate member is threadedly connected to the body. The rotary member is threadedly connected to the connector of a hose. The hose can be freely rotatable relative to the female connector to prevent being twisted.

### FIELD OF THE INVENTION

The present invention relates to a female connector for quickly connecting a hose connector, and more particularly, to a female connector which allows the hose to be rotatable and prevents the hose from being twisted.

### BACKGROUND OF THE INVENTION

A conventional female connector for connecting a hose is shown in FIGS. 8 and 9, and generally includes a body 6 which has a threaded hole 61, an end piece 7 having a threaded end 71 on the first end thereof and which is threadedly connected with the threaded hole 61. Another threaded end 710 is formed on the second end of the end piece 7 so as to be threadedly connected with a connector 8 of a hose 9. However, the body 6, the end piece 7 and the connector 8 are fixed when they are connected to each other, the hose 9 may be twisted when in operation because of the fixed connected status of the body 6, the end piece 7 and the connector 8. Once the hose 9 is twisted, the pressurized air form the compressor cannot be sent properly and affects the function of the pneumatic tool powered by the pressurized air.

The present invention intends to provide a female connector which is rotatable relative to the hose so as to improve the drawback mentioned above.

### SUMMARY OF THE INVENTION

The present invention relates to a method for making a female connector and the method comprises the follow steps:
step (a): setting a mediate member and a rotary member to an end of the female connector;
step (b): the rotary member having a stepped cylindrical portion and the mediate member having an inner hole which is located corresponding to the stepped cylindrical portion;
step (c): a seal ring mounted to the stepped cylindrical portion and the stepped cylindrical portion inserted into the inner hole of the mediate member, and
step (d): putting the mediate member and the rotary member into a mold unit and riveting the mediate member and the rotary member together, the rotary member being rotatable relative to the mediate member.

The present invention alternatively provides a method for making a female connector and the method comprises the follow steps:
step (a): setting a mediate member and a rotary member to an end of the female connector;
step (b): the rotary member having a stepped cylindrical portion and the mediate member having an inner hole which is located corresponding to the stepped cylindrical portion;
step (c): a seal ring mounted to the stepped cylindrical portion and the stepped cylindrical portion inserted into the inner hole of the mediate member, and
step (d): making a threaded hole defined in an end of the stepped cylindrical portion and providing a sleeve which has outer threads, the sleeve located within the inner hole of the mediate member and the threads threadedly connected to the threaded hole.

The present invention further relates to a female connector and comprises a body having a reception hole defined in the first end thereof and an inner threaded hole is defined in the second end of the body. A mediate member is a hollow member, and the first end of the mediate member is threadedly connected to the inner threaded hole and the second end of the mediate member has a stepped inner hole. A rotary member has a stepped cylindrical portion and a seal ring is mounted to the stepped cylindrical portion. The stepped cylindrical portion is inserted in the inner hole of the mediate member and the seal ring contacts a wall protruding from the inner periphery of the stepped inner hole.

Preferably, the stepped inner hole comprises a first partition and a second partition, and the wall is located between the first and second partitions. The inner diameter of the first partition is larger than that of the second partition.

Preferably, the stepped cylindrical portion comprises a first section and a second section, wherein an outer diameter of the first section is larger than that of the second section.

Preferably, the rotary is rotatably connected to the mediate member by way of riveting.

Preferably, the stepped cylindrical portion has a threaded hole defined in an end thereof, and a sleeve with outer threads is located within the inner hole of the mediate member and is threadedly connected to the threaded hole of the stepped cylindrical portion by the outer threads.

The primary object of the present invention is to provide a female connector which has a rotary member and a mediate member, the rotary member is connected to the connector of a hose, so that the hose is rotatable and not twisted.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the female connector of the present invention is to be connected with a male connector and a hose connector;

FIG. 2 is a cross sectional view of the female connector of the present invention;

FIG. 3 is an exploded view to show the female connector of the present invention;

FIG. 4 shows that the mediate member and the rotary member of the female connector of the present invention are riveted to each other;

FIG. 5 shows the method for making the female connector of the present invention;

FIG. 6 is a cross sectional view of another embodiment of the female connector of the present invention;

FIG. 7 shows the method for making the female connector in FIG. 6 of the present invention;

FIG. 8 is an exploded view to show the conventional female connector, and

FIG. 9 is a cross sectional view to show the conventional female connector.

### DETAILED DESCRIPTION OF THE PREFERRED EMBODIMENT

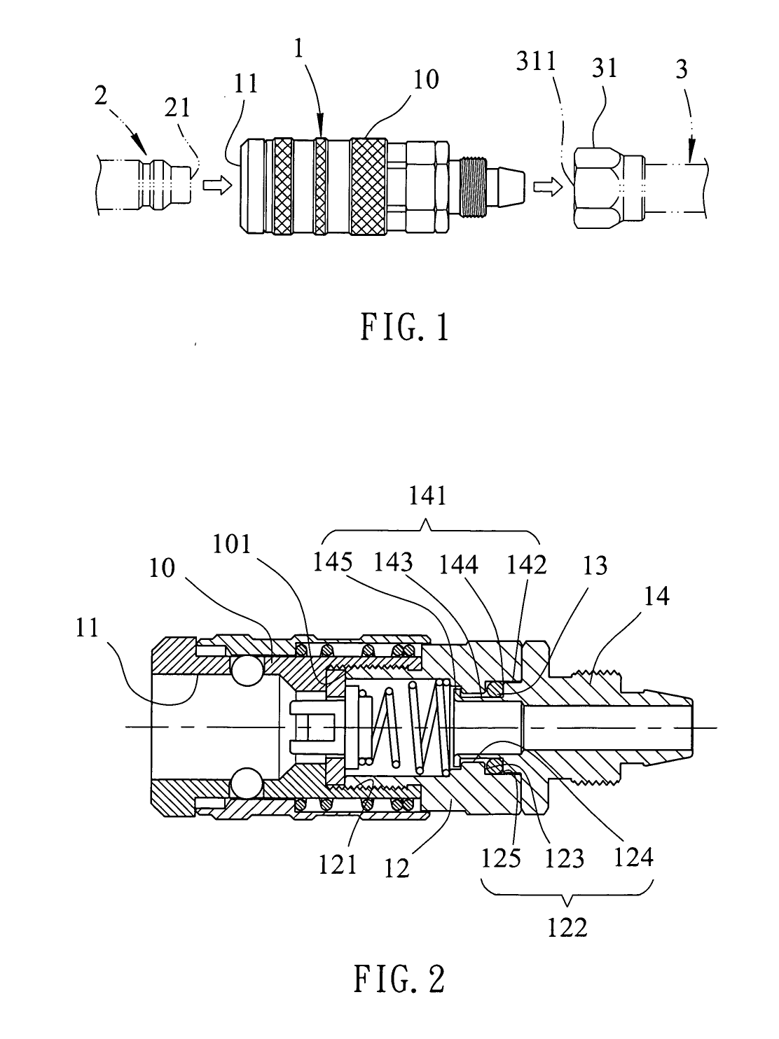

Referring to FIG. 1, the female connector 1 of the present invention comprises a body 10 which has a reception hole 11 defined in the first end thereof so that an end 21 of a male connector 2 is quickly connected to the reception hole 11. The second end of the female connector 1 is threadedly connected to the inner threads 311 of a hexagonal connector 31 of a hose 3. By the connection, the pneumatic equipment is connected with the compressor which provides high-pressure air to the pneumatic equipment.

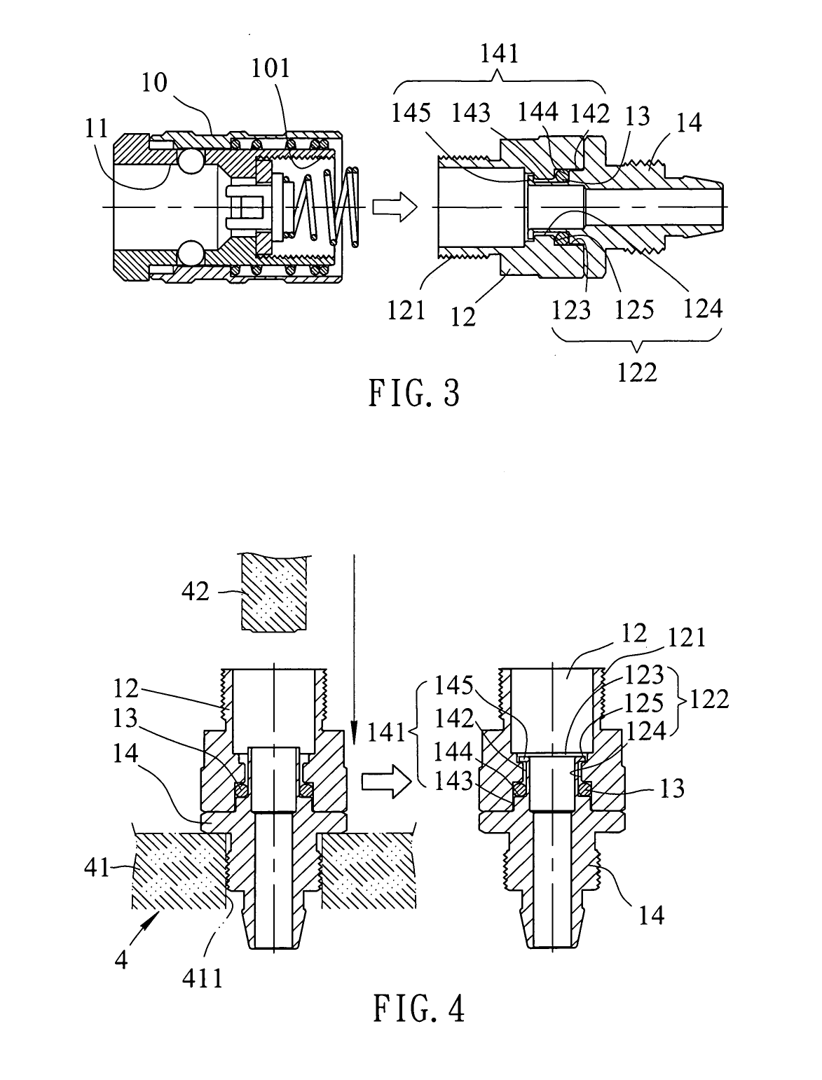

Referring to FIGS. 2 and 3, the female connector 1 comprises the body 10, a mediate member 12, a seal ring 13 and a rotary member 14. The body 10 has an inner threaded hole 101 defined in the second end of the body 10 so that the outer threads 121 of the meditate member 12 is threadedly connected to the inner threaded hole 101 of the body 10. The body 10 is well known and will not be described in detail.

The mediate member 12 is a hollow member. The first end of the mediate member 12 has the outer threads 121 which are threadedly connected to the inner threaded hole 101 and the second end of the mediate member 12 has a stepped inner hole 122 which includes a first partition 123 and a second partition 124, and a wall 125 is located between the first and second partitions 123, 124. The inner diameter of the first partition 123 is larger than that of the second partition 124.

The rotary member 14 has a stepped cylindrical portion 141 and a seal ring 13 is mounted to the stepped cylindrical portion 141. The stepped cylindrical portion 141 is inserted in the inner hole 122 of the mediate member 12 and the stepped cylindrical portion 141 comprises a first section. 142 and a second section 143. The outer diameter of the first section 142 is larger than that of the second section 143. A wall 144 is located between the first section 142 and the second section 143. The seal ring 13 contacts the wall 125 protruding from the inner periphery of the stepped inner hole 122 and the wall 144 to form an air-tight status.

It is noted that the stepped cylindrical portion 141 is rotatably inserted into the stepped inner hole 122 by way of riveting. Alternatively, the rotary member 14 can be composed by two parts.

As shown in FIG. 4, the rotary member 14 is put into the positioning holes 411 of the bottom mold 41 of a mold unit 4, and the seal ring 13 is mounted to the stepped cylindrical portion 141 and contacts the wall 144. The mediate member 12 is then put on the rotary member 14 with the stepped cylindrical portion 141 extending through the inner hole 122 of the mediate member 12. The top mold 42 of the mold unit 4 is then lowered to press the end face of the first section 142 of the stepped cylindrical portion 141 into form a flange 145 which contacts the wall 125. By the flange 145, the mediate member 12, the seal ring 13 and the rotary member 14 are combined together, while the rotary member 14 is rotatable relative to the mediate member 12. The mediate member 12 is then threadedly connected to the inner threads 101 to form the female connector 1.

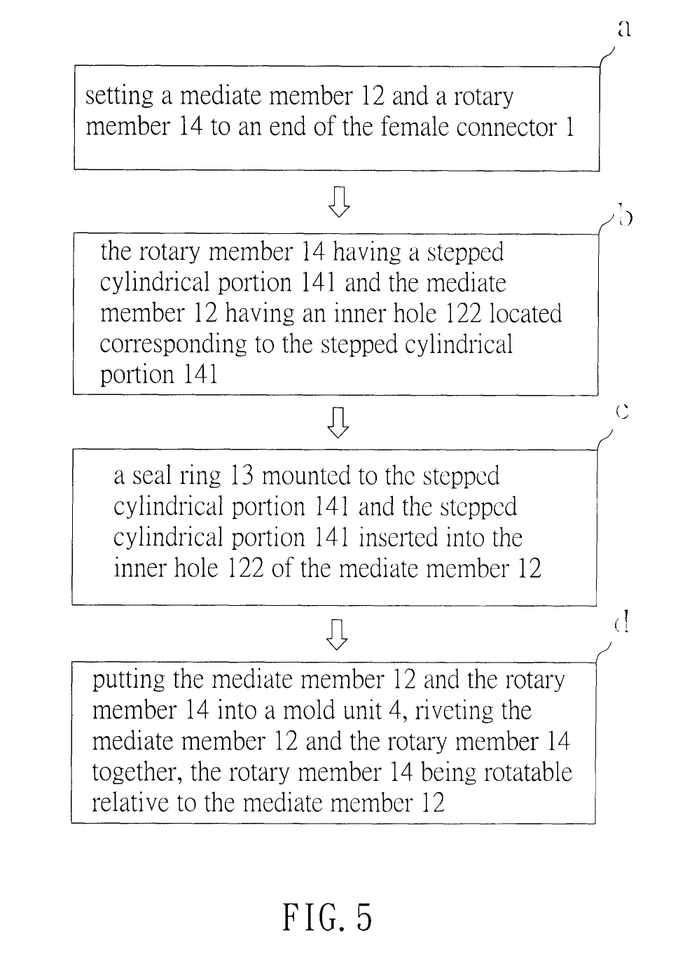

The method for making the female connector 1 is disclosed in FIG. 5 and which comprises the follow steps:
step (a): setting the mediate member 12 and the rotary member 14 to an end of the female connector 1;
step (b): the rotary member 14 having the stepped cylindrical portion 141 and the mediate member 12 having the inner hole 122 which is located corresponding to the stepped cylindrical portion 141;
step (c): the seal ring 13 mounted to the stepped cylindrical portion 141 and the stepped cylindrical portion 141 inserted into the inner hole 122 of the mediate member 12, and
step (d): putting the mediate member 12 and the rotary member 14 into the mold unit 4, riveting the mediate member 12 and the rotary member 14 together, the rotary member 14 being rotatable relative to the mediate member 12.

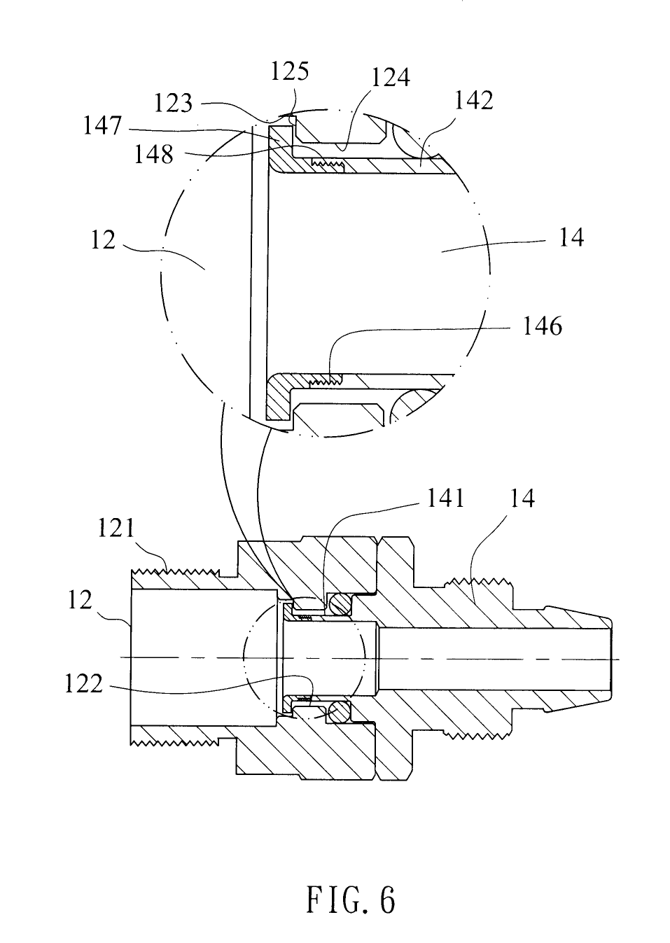

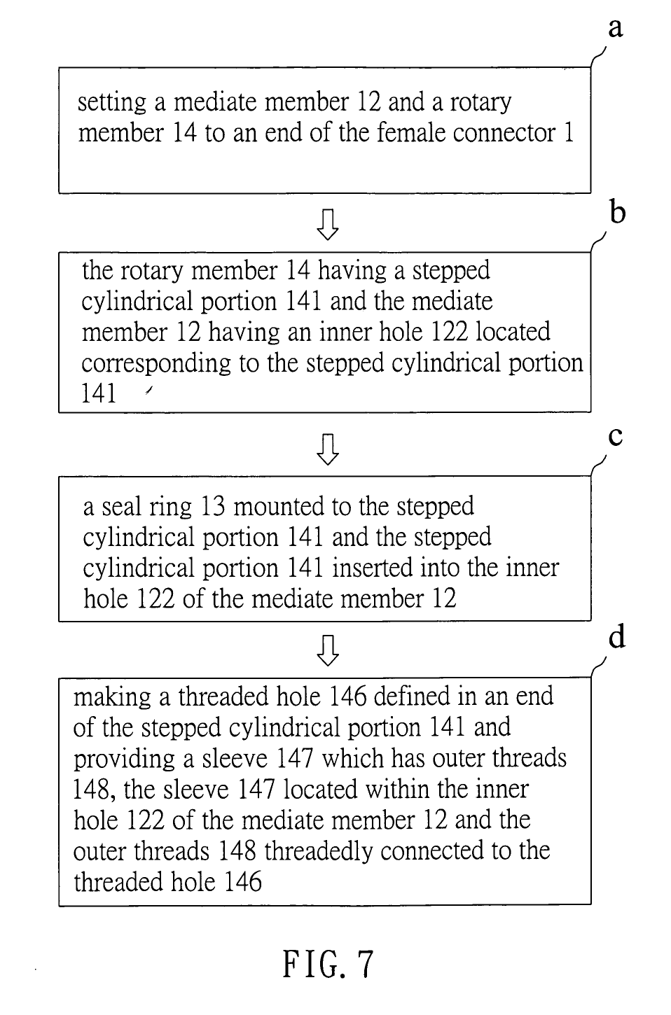

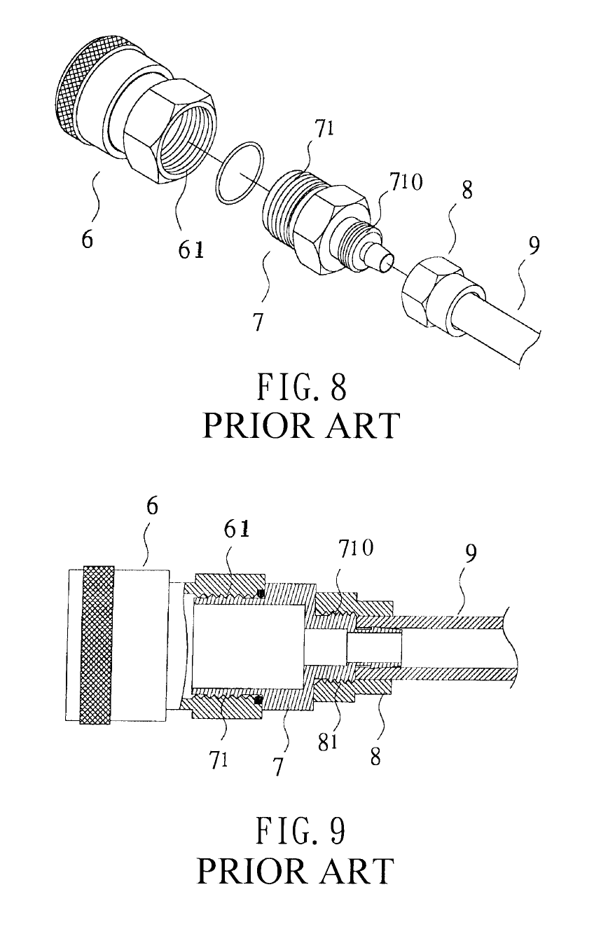

FIG. 6 shows that the rotary member 14 is composed of two parts, wherein a threaded hole 146 defined in one end of the stepped cylindrical portion 141 and a sleeve 147 has outer threads 148. The sleeve 147 is located within the inner hole 122 of the mediate member 12 and the outer threads 148 are threadedly connected to the threaded hole 146. By the sleeve 147, the mediate member and the rotary member 14 are combined together. The female connector 1 disclosed in FIG. 6 is made by the method disclosed in FIG. 7 and comprises the follow steps:
step (a): setting the mediate member 12 and the rotary member 14 to one end of the female connector 1;
step (b): the rotary member 14 having the stepped cylindrical portion 141 and the mediate member 12 having the inner hole 122 which is located corresponding to the stepped cylindrical portion 141;
step (c): the seal ring 13 mounted to the stepped cylindrical portion 141 and the stepped cylindrical portion 141 inserted into the inner hole 122 of the mediate member 12, and
step (d): making the threaded hole 146 defined in the end of the stepped cylindrical portion 141 and providing the sleeve 147 which has outer threads 148, the sleeve 147 located within the inner hole 122 of the mediate member 12 and the outer threads 148 threadedly connected to the threaded hole 146.

The stepped cylindrical portion 141 of the rotary member 14 is rotatably inserted into the inner hole 122, and the outer threads 122 of the mediate member 12 is threadedly connected to the inner threaded hole 101 of the body 1. The outer threads 140 of the rotary member 14 are threadedly connected to the connector 31 of the hose 3 so that the hose 3 can be freely rotated without being twisted.

While we have shown and described the embodiment in accordance with the present invention, it should be clear to those skilled in the art that further embodiments may be made without departing from the scope of the present invention.

What is claimed is:

1. A method for making a female connector, comprising the follow steps:
step (a): setting a mediate member and a rotary member to an end of the female connector;
step (b): the rotary member having a stepped cylindrical portion and the mediate member having an inner hole which is located corresponding to the stepped cylindrical portion;
step (c): a seal ring mounted to the stepped cylindrical portion and the stepped cylindrical portion inserted into the inner hole of the mediate member, and
step (d): putting the mediate member and the rotary member into a mold unit, riveting the mediate member and the rotary member together, the rotary member being rotatable relative to the mediate member.

2. A method for making a female connector, comprising the follow steps:
step (a): setting a mediate member and a rotary member to an end of the female connector;
step (b): the rotary member having a stepped cylindrical portion and the mediate member having an inner hole which is located corresponding to the stepped cylindrical portion;
step (c): a seal ring mounted to the stepped cylindrical portion and the stepped cylindrical portion inserted into the inner hole of the mediate member, and
step (d): making a threaded hole defined in an end of the stepped cylindrical portion and providing a sleeve which has outer threads, the sleeve located within the inner hole of the mediate member and the outer threads threadedly connected to the threaded hole.

3. A female connector comprising:
a body having a reception hole defined in a first end thereof and an inner threaded hole defined in a second end of the body;
a mediate member being a hollow member, a first end of the mediate member threadedly connected to the inner threaded hole and a second end of the mediate member having a stepped inner hole, and
a rotary member having a stepped cylindrical portion and a seal ring mounted to the stepped cylindrical portion, the stepped cylindrical portion inserted in the inner hole of the mediate member and the seal ring contacting a wall protruding from an inner periphery of the stepped inner hole.

4. The female connector as claimed in claim 3, wherein the stepped inner hole comprises a first partition and a second partition, the wall is located between the first and second partitions, an inner diameter of the first partition is larger than that of the second partition.

5. The female connector as claimed in claim 3, wherein the stepped cylindrical portion comprises a first section and a second section, an outer diameter of the first section is larger than that of the second section.

6. The female connector as claimed in claim 3, wherein the rotary is rotatably connected to the mediate member by way of riveting.

7. The female connector as claimed in claim 3, wherein the stepped cylindrical portion has a threaded hole defined in an end thereof, a sleeve with outer threads is located within the inner hole of the mediate member and is threadedly connected to the threaded hole of the stepped cylindrical portion by the outer threads.
